(19) United States
(12) Patent Application Publication
(10) Pub. No.: US 2002/0114565 A1
(43) Pub. Date: Aug. 22, 2002

(54) 3-port optical filtering assembly and method of manufacturing thereof

(76) Inventor: Kurt R. Francis, Yuma, AZ (US)

Correspondence Address: LEONARD TACHNER, A PROFESSIONAL LAW CORPORATION, 17961 SKY PARK CIRCLE, SUITE 38-E, IRVINE, CA, 92614-6364, US

(21) Appl. No.: 09/788,072

(22) Filed: Feb. 15, 2001

(51) Int. Cl. G02B 6/32; G02B 6/38

(52) U.S. Cl. 385/33; 385/34; 385/72; 385/74

(57) ABSTRACT

An optical filtering assembly used in temperature compensated 3-port filtering or isolating packages is described. The optical path is comprised of two (input and reflective) optical glass fibers inserted into dual-capillary glass ferrule to produce a fiber-ferrule sub-assembly, a collimating (GRIN or aspheric) lens, a spectral shaping glass filter and an output collimating assembly. The lens collimates the light emitted from the input optical fiber into parallel rays, which hit the filter. The filter splits the collimated light into two beams. The transmitted beam is spectrally modified by the filter, and couples into the output collimating assembly. The second beam is reflected from the filter through the lens into the adjacent (reflective) optical fiber. The optical components are assembled and aligned so that the transmitted and reflected light beams are collimated and their insertion losses (IL) are minimized. An alternative embodiment of an optical temperature compensated 3-port filtering is also described. The optical path is comprised of three sub-assemblies. The first sub-assembly includes input and output glass fibers inserted into a dual-capillary glass ferrule. The second one includes a transmissive optical glass fiber inserted into a single-capillary glass ferrule. The third sub-assembly includes sequentially positioned first collimating lens, filter, and second collimating lens, all of which are telescopically embedded into a thermally and structurally matched insulating and protective glass tube (enclosure). In the case of a prismatic glass filter, the third subassembly includes a filter block. The block is formed by sequentially positioning and bonding of a first glass disc, glass filter and a second glass disc. All filter block bonds are butt joints. A thermally and/or UV curable adhesive with low moisture diffusivity is used. The polished facets of the first, second and third sub-assemblies are matching.

### BACKGROUND OF THE INVENTION

1. Field of the Invention

The present invention relates to optical filtering and isolating packages and more specifically to 3-port optical filtering devices. The invention relates also to the manufacturing of these devices with adhesive bonding processes.

2. Prior Art

Multiple-port, filtering and isolating packages are widely used in local and long distance optical telecommunication networks. These networks comprise various spectral shaping and isolating optical filter assemblies as part of dense wavelength division multiplexing (DWDM) systems. The necessity to design reliable filters for such systems, which are subject to various thermal and mechanical loads during their 20 to 25 year lifetime, is of significant importance. A typical filter assembly comprises two (input and output) optical glass fibers inserted into a dual-capillary ferrule to produce a fiber-ferrule sub-assembly, a grated index (GRIN) lens; spectral shaping (isolating) glass filters. The optical components of the assembly are embedded into an isolating glass tube, which in turn is mechanically protected by the metal housing (enclosure). In a typical 3-port package, the above dual-fiber filter assembly is combined with the output collimating assembly leading to a single optical fiber. Conventional filter assemblies exhibit excessive insertion losses due to the coupling of the input fibers to the ferrule. The subsequent alignment of the collimator to the spectral shaping or isolating filter produces losses which have been higher than desired, resulting in degraded overall performance of the system particularly during exposure to ambient operating conditions.

In prior art systems; input glass ferrules employ one of two major designs. Either a single capillary of elliptical cross section or separate circular capillaries have been used, each with relatively short (1.8 mm) fiber-receiving ends. With such input ferrules, the optical fiber is subjected to an S-bending over the short conical end portion, which typically exceeds 50% of the fiber diameter (for a fiber having a 125μm diameter on a span of about 12 to 15 diameters in length). This excessive micro bending increases the insertion losses. Although the dual-capillary design reduces the lateral deflection of the fiber interconnects compared to the elliptical single-capillary design, the short length of the cone end of such ferrules cannot reduce the micro bending of the fiber and its inherent insertion loss. Fiber-ferrule subassemblies employing such ferrules are manufactured by the following steps: Fabricating the ferrules to hold the optical fibers (1); inserting the optical fibers stripped of their polymer coating into the respective ferrule capillaries (2); epoxy bonding them into the ferrule capillaries, including the conical end portions (3); grinding an 8 degree facet of the fiber-ferrule (4); polishing the facet (5) and depositing on the polished surface an antireflection (AR) coating. Once finished, the fiber-ferrule is aligned and assembled with the GRIN or ball lens collimator whose surface is coated with antireflection (AR) films, and then embedded into the insulating glass tube, which, in turn, is protected by a metal housing to provide structural integrity, robustness and thermal insulation to the assembly.

There are two different technical solutions used in the design of bonds securing the components of a filter assembly. A low compliance bond between thermally well matched fibers and ferrule is an approach commonly used by a majority of manufacturers. The adhesives used are heat-curable epoxies with high Young's modulus (E>10,000 psi) and moderate to high thermal expansion coefficients (α=40 to 60 10⁻⁶ degrees C.⁻¹). A typical example would be 353ND Epo-Tek epoxy adhesive. In addition, the bond thickness used is very small.

Silicon adhesives are used to bond thermally mismatched glass tubes with metal housings and glass filters with metal holders. In these joints, a high compliance design is used. The silicones, which can be cured between 20-150 degrees Celsius in the presence of moisture, are typically characterized by an extremely low Young's Modulus (E <500 psi) and high thermal expansion (α=180 to 250 10₋₆ degrees C.⁻¹). A typical example would be DC 577 silicone, which can be used to bond a metal filter holder to a GRIN lens.

Adhesive bonding with subsequent soldering or welding is required to encapsulate a filtering assembly into a three-port package or DWDM device. A precise alignment achieved during initial assembly of a filter prior to final packaging can be easily decreased due to the high temperature thermal cycle associated with soldering or welding during packaging of the component. Such prior art manufacturing processes and resulting components have several problems resulting from the fact that the optical components experience stresses due to the thermal contraction mismatch between the glass and metal materials, polymerization shrinkage in adhesive bonds, and structural constraints induced by bonding and final soldering during encapsulation. These stresses lead to displacements of optical components during bonding and soldering, resulting in 0.3 to 1.0 dB increase in the insertion loss.

Such a filter package enclosure, which is typically formed of six to eight concentric proactive units, has micron transverse tolerances. Maintaining these tolerances requires precision matching, time-consuming alignment, and soldering with frequent rework. As a result of these limitations, the optical performance specifications are lowered and cost is increased. As an example, soldering typically includes several re-flow cycles. This induces local thermal stresses in the nearby adhesive bonds and leads to the degradation of the polymer adhesive, resulting in repositioning of optical components and a shift in the spectral filter performance. With such designs, soldering may also result in the contamination of optical components through direct contact with molten solder and/or flux.

Although both the collimating subassemblies and housings are cylinders, the alignment of commercially available optical components, which exhibit a random distribution of optical and structural characteristics, requires some lateral and angular repositioning of the subassemblies. This repositioning of the optical subassemblies is limited by the gap in the solder joint and the ratio of this gap to the length of the subassembly. The lateral and angular repositioning observed in some isolators can be as high as 0.05 to 0.3 mm and 0.5 to 1.5 degrees, respectively. The soldering of noncapillary gaps incurs well-known difficulties, such as high volume shrinkage of the solder, void formation and contamination of optical components.

However, for many applications, it is desirable to obtain a high accuracy thermally compensated filtering or isolating three-port package that can be relatively inexpensive and reliable. Additionally, a package design should be adequate not only to mechanically protect the fragile optical components, but also to compensate for and minimize the thermally induced shift in spectral performance. Thus, there exists a need for a process for manufacturing a filtering (or isolating) three-port package, which has a construction which is miniaturized, has a low insertion loss, is inexpensive to manufacture and which results in a filter having reliable, long-term operation.

### SUMMARY OF THE INVENTION

An optical filtering assembly used in temperature compensated 3-port filtering or isolating packages is described. The optical path is comprised of two (input and reflective) optical glass fibers inserted into dual-capillary glass ferrule to produce a fiber-ferrule sub-assembly, a collimating (GRIN or aspheric) lens, a spectral shaping glass filter and an output collimating assembly. The lens collimates the light emitted from the input optical fiber into parallel rays, which hit the filter. The filter splits the collimated light into two beams. The transmitted beam is spectrally modified by the filter, and couples into the output collimating assembly. The second beam is reflected from the filter through the lens into the adjacent (reflective) optical fiber. The optical components are assembled and aligned so that the transmitted and reflected light beams are collimated and their insertion losses (IL) are minimized.

An alternative embodiment of an optical temperature compensated 3-port filtering is also described. The optical path is comprised of three sub-assemblies. The first subassembly includes input and output glass fibers inserted into a dual-capillary glass ferrule. The second one includes a transmissive optical glass fiber inserted into a single-capillary glass ferrule. The third sub-assembly includes sequentially positioned first collimating lens, filter, and second collimating lens, all of which are telescopically embedded into a thermally and structurally matched insulating and protective glass tube (enclosure). In the case of a prismatic glass filter, the third subassembly includes a filter block. The block is formed by sequentially positioning and bonding of a first glass disc, glass filter and a second glass disc. All filter block bonds are butt joints. A thermally and/or UV curable adhesive with low moisture diffusivity is used. The polished facets of the first, second and third sub-assemblies are matching.

The first lens collimates the light emitted from the input optical fiber into parallel rays, which hit the filter block The filter splits the collimated light into two beams. The transmitted beam is spectrally modified by the filter, and couples into the second lens and then into the transmissive fiber. The second beam is reflected from the filter through the first lens into the adjacent (reflective) optical fiber. The optical components are assembled and aligned so that the transmitted and reflected light beams are collimated and their insertion losses (IL) are minimized.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a cross-sectional side view of the first embodiment of the invention;

FIG. 2 is a cross-sectional side view of the second embodiment of the invention; and

FIG. 3 is a three-dimensional view of the filter and collimating lenses used in the second embodiment of FIG. 2.

### DETAILED DESCRIPTION OF PREFERRED EMBODIMENTS

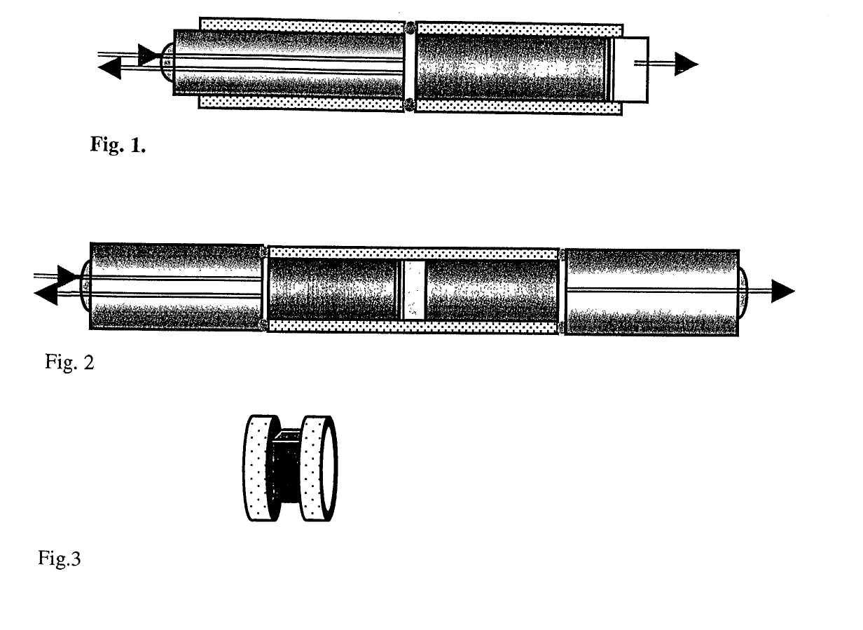

As shown in FIG. 1 of a first embodiment of the invention, the optical filtering assembly includes two aligned and bonded parts. The first part is the fiber-ferrule telescopically embedded into the thermally and structurally matched insulating and protective glass tube (enclosure). The second part is the lens with the pre-assembled filter that is also telescopically embedded into the thermally and structurally matched insulating and protective glass tube (enclosure). The protective tubes used in both parts, therefore, made from the identical glass material. A thermally and/or UV curable adhesive with low moisture diffusivity is used in these telescopic joints. The preassembled parts are then aligned to optimize both the insertion losses (IL) in the transmitted and reflected light beams. To retain the achieved alignment, the butt adhesive joint is formed at the end-faces of the parts. To minimize the thermal excursion and re-positioning of the optical components in this joint, the adhesive is applied to form a thin ring layer which is symmetrical about the optical axes of the package. In addition to this, the width of the ring layer is limited to cover the end-face of the glass tube. To provide the full a thermalization of the assembly, all components, including the filter substrate, are made from well thermally matched glasses and a thermally and/or UV curable adhesive with low moisture diffusivity are used in all joints. As shown in FIGS. 2 and 3, the optical filtering assembly of a second embodiment of the invention includes three aligned and bonded sub-assemblies: A dual-fiber ferrule, a single-fiber ferrule, and a collimating and filtering system. These three pre-assembled parts are then aligned to optimize both the insertion losses (IL) in the transmitted and reflected light beams. To retain the achieved alignment, a butt adhesive joint is formed at the end-faces of the parts. To minimize the thermal excursion and re-polishing of the optical components in this joint, the adhesive is applied to form a thin ring layer, which is symmetrical about the optical axes of the package. In addition, the width of the ring layer is limited to cover the end-face of the glass tube. To provide almost full a-thermalization of the assembly, the glass of ferrules and discs and the glass of the protective tube have to be well thermally matched. A thermally and/or UV curable adhesive with low moisture diffusivity are used in these butt joints.

Having thus disclosed preferred embodiments of the invention, it being understood that various modifications and additions are contemplated and that the scope of protection afforded hereby is limited only by the appended claims and their equivalents, what is claimed is:

1. An optical filtering device having an optical input and first and second optical outputs, the first optical output being spectrally identical to the optical input, the second optical output being spectrally different from the optical input; the device comprising:
a dual fiber-ferrule telescopically embedded in a first insulated glass tube for carrying said optical input and said first optical output; and
an optical collimating lens and filter telescopically embedded in a second insulated glass tube, said second glass tube having a dual fiber-ferrule for carrying said optical input to said lens and filter for generating said second optical output, and for carrying said first optical output to said first insulated glass tube;
said first and second insulated glass tubes being joined in axially abutting relation.

2. The optical filtering device recited in claim 1 wherein said first and second insulated glass tubes are joined by an adhesive.

3. The optical filtering device recited in claim 2 wherein said adhesive is in the form of a ring positioned between axially abutting ends of said tubes.

4. The optical filtering device recited in claim 3 wherein said first and second insulated glass tubes have substantially equal inner and outer diameters, respectively.

5. The optical filtering device recited in claim 4 wherein said adhesive ring has an inner and outer diameter substantially equal to the inner and outer diameters of said tubes.

6. The optical filtering device recited in claim 1 wherein said first and second glass tubes are made of identical glass materials.

7. An optical filtering device having an optical input and first and second optical outputs, the first optical output being spectrally identical to the optical input, the second optical output being spectrally different from the optical input; the device comprising,
a dual fiber-ferrule telescopically embedded in a first insulated glass tube for carrying said optical input and said first optical output; and
a filter having input and output collimating lenses telescopically embedded in a second insulated glass tube, said second glass tube having a dual fiber-ferrule for carrying said optical input to said filter for generating said second optical output, and for carrying said first optical output to said first insulated glass tube;
a single fiber-ferrule telescopically embedded in a third insulated glass tube for carrying said second optical out of said device;
said first, second and third insulating glass tubes being sequentially joined in axially abutting relation.

8. The optical filtering device recited in claim 7 wherein said first, second and third insulated glass tubes are joined by an adhesive.

9. The optical filtering device recited in claim 8 wherein said adhesive is in the form of respective rings positioned between axially abutting ends of said tubes.

10. The optical filtering device recited in claim 9 wherein said first, second and third insulated glass tubes have substantially equal inner and outer diameters, respectively.

11. The optical filtering device recited in claim 10 wherein each said adhesive ring has an inner and outer diameter substantially equal to the inner and outer diameters of said tubes.

12. The optical filtering device recited in claim 7 wherein said first and second glass tubes are made of identical glass materials.

13. A method of fabricating an optical filtering device, the device having an optical input and first and second optical outputs, the first optical output being spectrally identical to the optical input, the second optical output being spectrally different from the optical input; the method comprising the steps of:
a) providing a plurality of insulating glass tubes;
b) telescopically embedding a dual fiber ferrule in at least one of said tubes;
c) telescopically embedding a filter and at least one collimating lens in at least one other of said tubes; and
d) joining said tubes in serial abutting relation using a ring of adhesive between opposing tube faces.
